(19) United States
(12) Patent Application Publication
(10) Pub. No.: US 2010/0295270 A1
(43) Pub. Date: Nov. 25, 2010

(54) ENERGY-DISSIPATION SYSTEM

(75) Inventors: Andrew W. Marsden, Hingham, MA (US); Ward Fritz, Chelsea, MA (US); Walter S. Bezaniuk, Berkley, MA (US); Joe Langley, Foxboro, MA (US); David Amirault, Easton, MA (US)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 12/469,575

(22) Filed: May 20, 2009

(51) Int. Cl. B60R 21/16; A47C 1/08

(52) U.S. Cl. 280/728.2; 297/250.1

(57) ABSTRACT

A child restraint includes a juvenile vehicle seat and an energy-absorption apparatus coupled to the juvenile vehicle seat. The energy-absorption apparatus is configured to absorb external energy associated with an external impact force applied to the energy-absorption apparatus.

### BACKGROUND

The present disclosure relates to energy-absorbing apparatus, and in particular, to devices for dissipating energy associated with external impact forces. More particularly, the present disclosure relates to an energy-dissipation system included in a juvenile product such as a child-restraint system.

When exposed to an external impact force, a juvenile vehicle seat at rest on a seat in a car or truck will accelerate as it moves to a new location in the passenger compartment of a car or truck. A child seated in such a moving juvenile vehicle seat will also accelerate as the juvenile vehicle seat moves in the passenger compartment.

A g-load is a measurement of an object's acceleration measured in gs. The g is a non-SI unit equal to the nominal acceleration due to gravity on earth at sea level. A short-term acceleration experienced by a child seated in a juvenile vehicle seat (or any other juvenile seat) that moves suddenly is called a shock and is measured in gs.

### SUMMARY

An energy-dissipation system in accordance with the present disclosure is included in an apparatus that is exposed to external impact forces. In an illustrative embodiment, the energy-dissipation system is coupled to a juvenile vehicle seat to provide a child-restraint system.

In illustrative embodiments, the energy-dissipation system includes a ride-down pad coupled to a headrest included in a juvenile vehicle seat. The ride-down pad includes one or more air bags and a deformable bag-shape retainer shield surrounding the one or more air bags.

Each air bag includes an air chamber filled only with air or other suitable fluid to assume an inflated shape. The deformable bag-shape retainer shield surrounds the air bag(s) to block premature deflation of the air bag(s).

When the juvenile vehicle seat is exposed to an external impact force, the deformable bag-shape retainer shield is deformed to expose the air bag(s) stored therein to such a force. The normally inflated air bag(s) deflate to cause the ride-down pad to absorb external energy associated with the external impact force to minimize g-loads experienced by a child seated on the juvenile vehicle seat. In one embodiment, the deformable bag-shape retainer shield is bowl-shaped and in another embodiment, the shield is defined by an endless strip of material.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a child-restraint system including a juvenile vehicle seat having a seat bottom and a seat back extending upwardly from the seat bottom and an energy-dissipation system coupled to the seat back and made in accordance with a first embodiment of the present disclosure, with portions broken away, and showing that the seat back comprises a backrest coupled to the seat bottom and a headrest coupled to the backrest and that the energy-dissipation system comprises a right-side ride-down pad mounted on an inner wall of a first side-wing panel included in the headrest and a left-side ride-down pad mounted on an inner wall of an opposite second side-wing panel included in the headrest and showing an external impact force about to strike an outer portion of the first side-wing panel carrying the right-side ride-down pad;

FIG. 2 is an enlarged perspective view of the right-side ride-down pad mounted on the first side-wing panel of the headrest shown in FIG. 1, with portions broken away;

FIG. 3 is an exploded perspective assembly view of the right-side ride-down pad of FIG. 2 showing that the ride-down pad is a multi-stage unit comprising (1) a first (inner) force dissipater including a first vessel (e.g., bag) formed to include a first air chamber and forwardly facing first and second air-discharge ports (e.g., cross-shaped slits) opening into the first air chamber, (2) a second (outer) force dissipater including a second vessel (e.g., bag) formed to include a second air chamber and forwardly facing first and second air-discharge ports (e.g., cross-shaped slits) opening into the second air chamber, and (3) a deformable bag-shape retainer shield configured to mount on the first side-wing panel to retain both of the first and second bags in an inflated shape until the right-side ride-down pad is deformed as suggested in FIG. 6 and showing that the deformable bag-shape retainer shield is defined by a monolithic bowl-shaped component comprising a round top wall and an annular side wall arranged to surround the first and second bags;

FIG. 4 is an enlarged sectional view taken along line 4-4 of FIG. 1 showing placement of the right-side ride-down pad on an inner wall of a first side-wing panel of the headrest before any deformation of the deformable bag-shape retainer shield and deflation of the first and second bags is caused by application of an external impact force to the juvenile seat;

FIG. 5 shows deformation and partial deflation of each of the first and second bags in the right-side ride-down pad following sudden application of an external impact force to the first side-wing panel of the headrest to deform the deformable bag-shape retainer shield covering the first and second bags and showing that air is discharged from the first air chamber in the first bag and the second air chamber in the second bag into an interior region formed in the deformable bag-shape retainer shield when the shield and the first and second bags are deformed and squeezed between a seated child and the external impact force to minimize the magnitude of a resulting force applied to a child seated in a juvenile vehicle seat including the right-side ride-down pad and thereby to minimize the g-load (acceleration) caused by the resulting force and experienced by the seated child;

FIG. 6 is a perspective view of a child-restraint system including a juvenile vehicle seat having a seat bottom and a seat back extending upwardly from the seat bottom and an energy-dissipation system coupled to the seat back and made in accordance with a second embodiment of the present disclosure, with portions broken away, and showing that the seat back comprises a backrest coupled to the seat bottom and a headrest coupled to the backrest and that the energy-dissipation system comprises a right-side ride-down pad mounted on an inner wall of a first side-wing panel included in the headrest and a left-side ride-down pad mounted on an inner wall of an opposite second side-wing panel included in the headrest and showing an external impact force about to strike an outer portion of the first side-wing panel carrying the right-side ride-down pad;

FIG. 7 is an enlarged perspective view of the right-side ride-down pad mounted on the first side-wing panel of the headrest shown in FIG. 6, with portions broken away;

FIG. 8 is an exploded perspective assembly view of the right-side ride-down pad of FIG. 2 showing that the ride-down pad is a multi-stage unit comprising (1) a first (inner) force dissipater including a first vessel (e.g., bag) formed to include a first air chamber and forwardly facing first and second air-discharge ports (e.g., cross-shaped slits) opening into the first air chamber, (2) a second (outer) force dissipater including a second vessel (e.g., bag) formed to include a second air chamber and a forwardly facing first and second air-discharge ports (e.g., cross-shaped slits) opening into the second air chamber, and (3) a deformable bag-shape retainer shield defined by an endless strip of pliable (e.g., corrugated) material and configured to mount on the first-side-wing panel to retain both of the first and second bags in an inflated shape until the right-side ride-down pad is deformed as suggested in FIG. 6;

FIG. 9 is an enlarged sectional view taken along line 9-9 of FIG. 6 showing placement of the right-side ride-down pad on an inner wall of a first side-wing panel of the headrest; and

FIG. 10 shows deformation and partial deflation of each of the first and second bags in the right-side ride-down pad following sudden application of an external impact force to the first side-wing panel of the headrest to deform the deformable bag-shape retainer shield surrounding the first and second bags and showing that air is discharged from the first air chamber in the first bag and the second air chamber in the second bag into an interior region formed in the deformable bag-shape retainer shield when the shield and the first and second bags are deformed and squeezed between a seated child and the external impact force to minimize the magnitude of a resulting force applied to a child seated in a juvenile vehicle seat including the right-side ride-down pad and thereby to minimize the g-load (acceleration) caused by the resulting force and experienced by the seated child.

### DETAILED DESCRIPTION

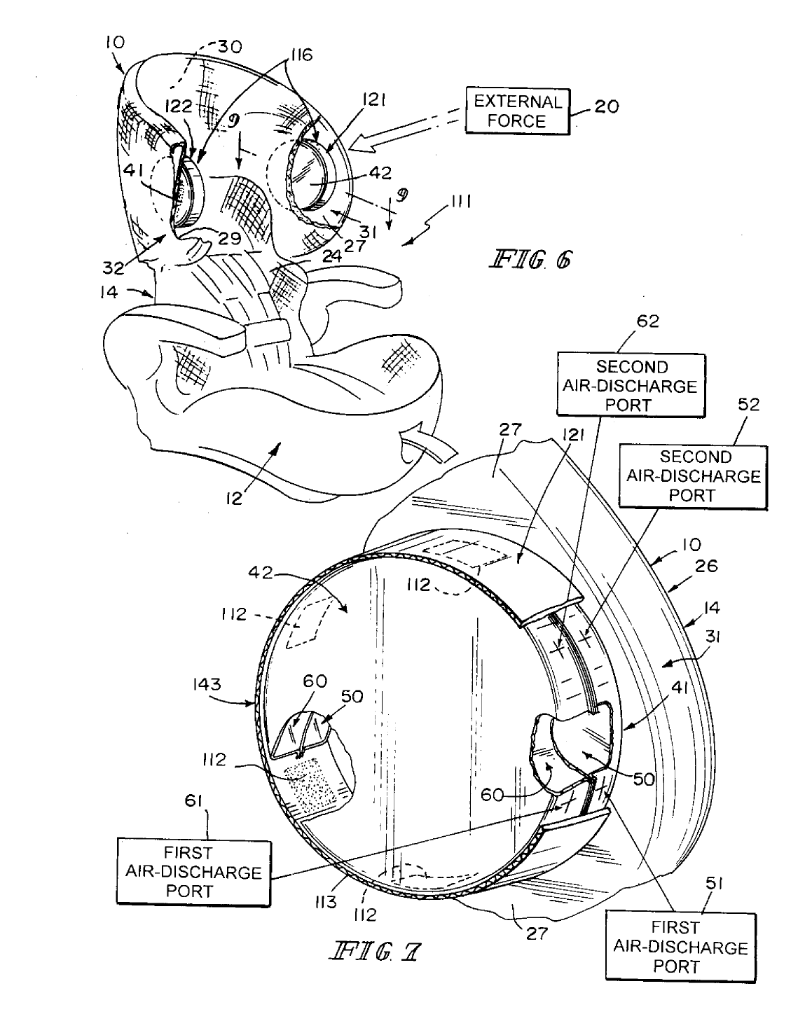

An illustrative child-restraint system 11 includes a juvenile vehicle seat 10 and an energy-dissipation system 16 coupled to juvenile vehicle seat 10 as suggested in FIG. 1. In illustrative embodiments, juvenile vehicle seat 10 includes a seat bottom 12 and a seat back 14 extending upwardly from seat bottom 12 and carrying energy-dissipation system 16. Another illustrative child-restraint system 111 includes an energy-dissipation system 116 coupled to a seat back 14 of a juvenile vehicle seat 10 as suggested in FIG. 6. It is within the scope of this disclosure to mount energy-dissipation systems 16 or 116 on a juvenile seat or other device to dissipate energy transferred to such a seat or device by means of an external impact force applied to the seat or device.

Each energy-dissipation system 16, 116 comprises a ride-down pad that is designed to minimize the g-loads experienced by a child seated on seat bottom 12 of juvenile vehicle seat 10 during exposure of seat 10 to an external impact force. Ride-down pads 21, 22 in accordance with a first embodiment of the present disclosure are shown, for example, in FIGS. 1-5. Ride-down pads 121, 122 in accordance with a second embodiment of the present disclosure are shown, for example, in FIGS. 6-10. Reference is hereby made to U.S. application Ser. No. 12/327,376 filed Dec. 4, 2008, the entirety of which is hereby incorporated by reference herein, for disclosures of various ride-down pad configurations and mounting arrangements.

As suggested in FIG. 1, seat back 12 of juvenile vehicle seat 10 includes a backrest 24 arranged to extend upwardly from seat bottom 12 and a headrest 26 coupled to backrest 24. Right-side ride-down pad 21 is coupled to an inner wall 27 of a first side-wing panel 31 included in headrest 26 as shown in FIGS. 1, 2, 9, and 10. Left-side ride-down pad 22 is coupled to an inner wall 29 of a second side-wing panel 32 included in headrest 26 as shown in FIG. 1. A rear panel 30 is included in headrest 26 and arranged to interconnect first and second side-wing panels 31, 32 as suggested in FIG. 1.

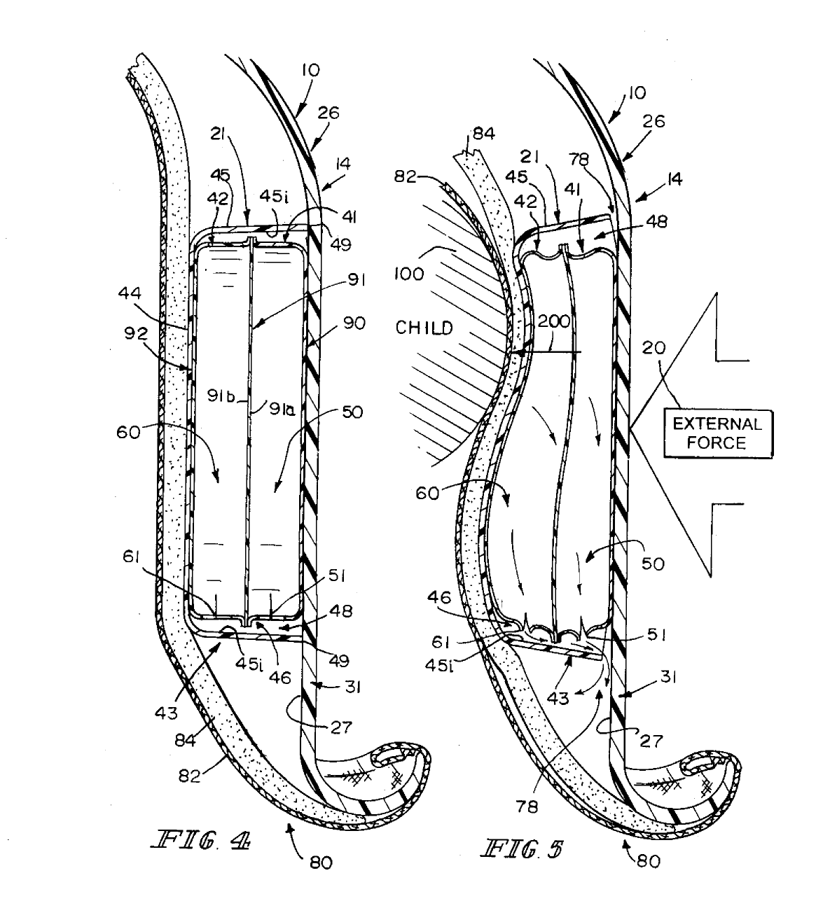

During a collision or other incident, application of an external impact force 20 to right-side ride-down pad 21 causes energy to be transferred from an impacting object (not shown) to right-side ride-down pad 21 as suggested in FIGS. 1 and 5. Ride-down pad 21 absorbs that transferred energy as suggested in FIG. 5 to minimize the magnitude of a resulting force 200 applied to a child 100 seated in juvenile vehicle seat 10 during the collision. Ride-down pad 21 functions to minimize the g-loads (acceleration) experienced by child 100 seated on seat bottom 12 of juvenile vehicle seat 10 during exposure of seat 10 to external impact force 20 as suggested in FIG. 5. Ride-down pad 21 also functions to maximize the time interval (i.e., ride-down time) between the moment the impacting object strikes ride-down pad 21 to apply the external impact force 20 and the moment that resulting force 200 reaches zero. Each of ride-down pads 22, 121, and 122 functions in a manner similar to ride-down pad 21.

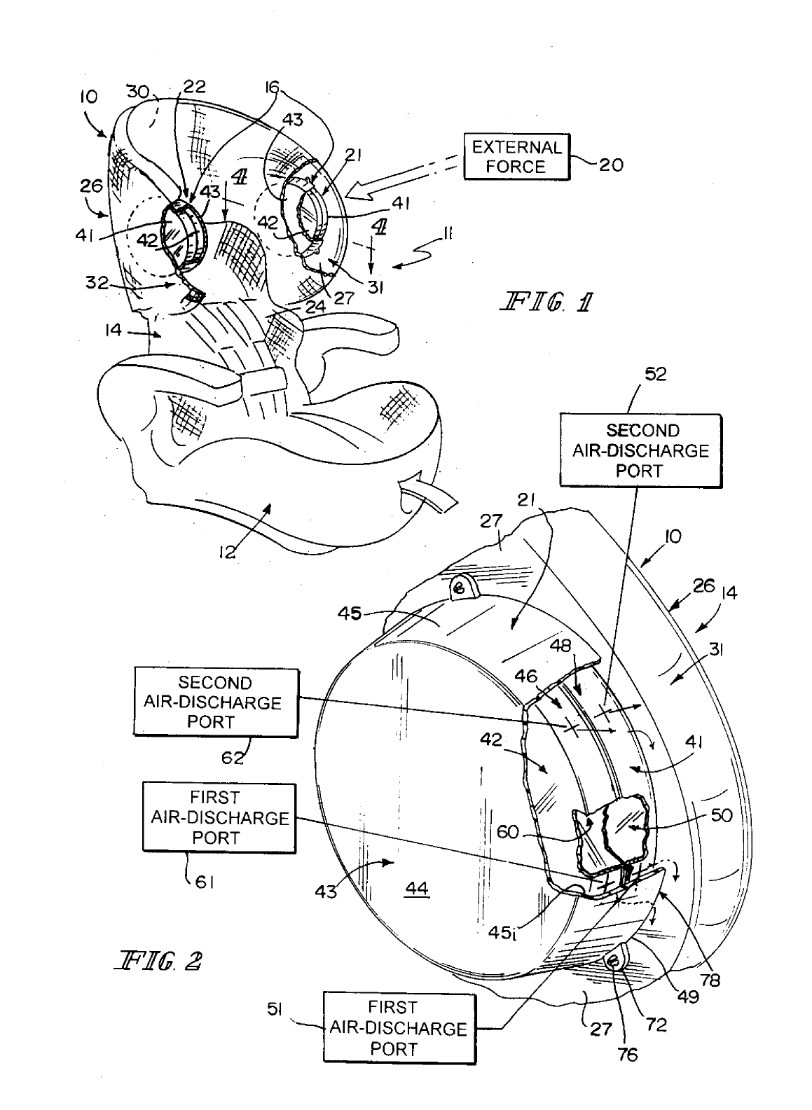

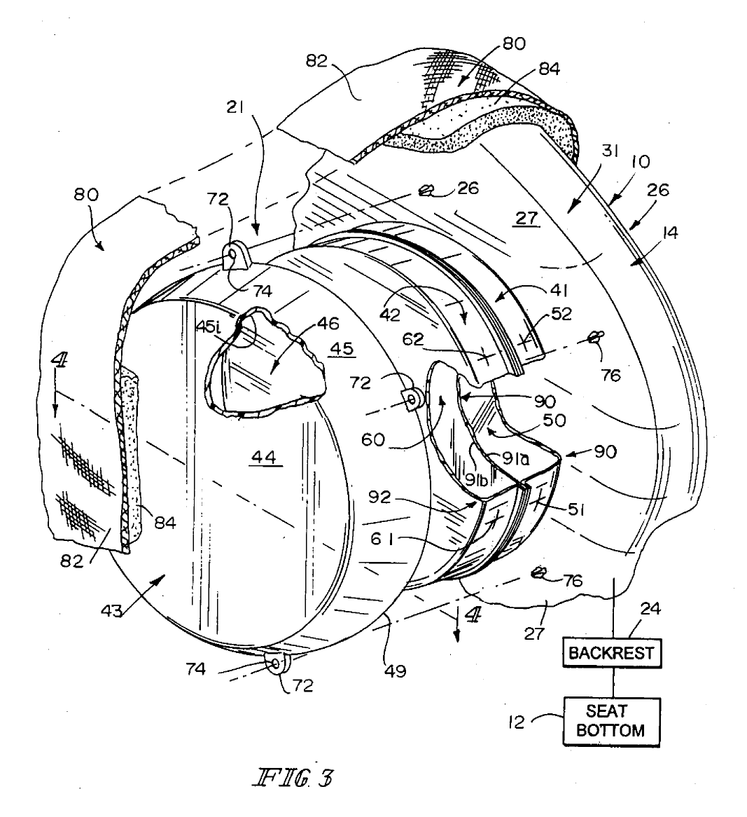

Right-side ride-down pad 21 includes a first bag 41, a second bag 42, and a deformable bag-shape retainer shield 43 providing a protective cover for first and second bags 41, 42 as suggested in FIGS. 2-4. Each of first and second bags 41, 42 is inflated normally to assume an inflated shape as shown, for example, in FIGS. 1-4. Deformable bag-shape retainer shield 43 is configured to provide means for retaining each of first and second bags 41, 42 in its inflated shape until a sufficient external impact force 20 is applied to juvenile vehicle seat 10 to cause deformation of deformable bag-shape retainer shield 43 as suggested in FIG. 5 so that premature deflation of first and second bags 41, 42 is avoided. Left-side ride-down pad 22 is similar in construction to right-side ride-down pad 21.

First bag 41 is formed to include a first air chamber 50 and normally closed first and second air-discharge parts 51, 52 opening into first air chamber 50 as suggested in FIGS. 2-5. First air chamber 50 is filled with air (or other suitable fluid) to cause first bag 41 normally to assume an inflated shape as suggested in FIGS. 2-4. In an illustrative embodiment, first air chamber 50 contains only air.

Second bag 42 is formed to include a second air chamber 60 and normally closed first and second air-discharge parts 61, 62 opening into second air chamber 60 as suggested in FIGS. 2-5. Second air chamber 60 is filled with air (or other suitable fluid) to cause second bag 42 normally to assume an inflated shape as suggested in FIGS. 2-4. In an illustrative embodiment, second air chamber 60 contains only air.

Deformable bag-shape retainer shield 43 includes a top wall 44 and a side wall 45 coupled to top wall 44 to form an interior region 46 containing first and second bags 41, 42 as suggested in FIGS. 2-5. Shield 43 is bowl-shaped in an illustrative embodiment and is coupled to inner wall 27 of first side-wing panel 31 of headrest 26 to form a bag-receiving space 48 therebetween, which space 48 is substantially coextensive with interior region 46 of shield 43 as shown, for example, in FIG. 2. Shield 43 is made of a deformable but somewhat rigid (e.g., plastics) material to assume a predetermined shape to shield first and second bags 41, 42 from incidental contact so that first and second bags 41, 42 remain in their inflated shapes until shield 43 is deformed as suggested in FIG. 5 and first and second bags 41, 4 are exposed to an external impact force and deflated partly or fully.

In an illustrative embodiment, top wall 44 of shield 43 is round and side wall 45 is an endless strip having a frustoconical shape as suggested in FIGS. 2 and 3. Side wall 45 is arranged to surround a perimeter edge of each of first and second bags 41, 42 as suggested in FIG. 2. Top wall 44 is coupled to side wall 45 to lie in spaced-apart relation to a portion of inner wall 27 of first side-wing panel 31 to locate bag-receiving space 48 therebetween. Side wall 45 has an annular bottom edge 49 arranged normally to mate with inner wall 27 as suggested in FIGS. 2 and 4. Top wall 44 is made of a plastics material and arranged to cooperate with side wall 45 (also made of the same plastics material) to form a monolithic element as suggested in FIGS. 2-5.

Child restraint 11 also includes anchor means 70 for coupling side wall 45 of deformable bag-shape retainer shield 43 to inner wall 27 of first side-wing panel 31 of headrest 26 as suggested in FIGS. 2 and 3. Anchor means 70 includes a mount tab 72 coupled to side wall 45 and formed to include a fastener-receiver aperture 74 and an upstanding fastener 76 coupled to inner wall 27. Fastener 76 is arranged to extend through fastener-receiver aperture 74 as suggested in FIGS. 2 and 3 to couple side wall 45 to inner wall 27. In an illustrative embodiment, there is not a sealed connection between side wall 45 and inner wall 27 and side wall 45 may deform somewhat or otherwise provide a vent space 78 between side wall 45 and inner wall 27 as suggested, for example, in FIGS. 2 and 5. In the illustrated embodiment, several companion pairs of mount tabs 72 and fasteners 76 are provided around the periphery of side wall 45.

In an illustrative embodiment, an outer cover 80 is coupled to headrest 26 and arranged to cover each of right-side and left-side ride-down pads 21, 22. Outer cover 80 functions to dissipate energy associated with external impact forces 20 and to protect ride-down pads 21, 22 from damage. In an illustrative embodiment, outer cover 80 includes an outer skin 82 and a cushion 84 under outer skin 82 as shown, for example, in FIGS. 3-5.

As suggested in FIG. 5, each of first and second air-discharge ports 51, 52 provided in first bag 41 are formed to include means for discharging air from first air chamber 50 to surroundings (e.g., interior region 46 and bag-receiving space 48) outside first bag 41 at a metered rate when first bag 41 is exposed to external impact force 20 after deformation of deformable bag-shape retainer shield 43. Similarly, each of first and second air-discharge ports 61, 62 provided in second bag 42 are formed to include means for discharging air from second air chamber 60 to surroundings (e.g., interior region 46 and bag-receiving space 48) outside second bag 42 at a metered rate when second bag 42 is exposed to external impact force 20 after deformation of deformable bag-shape retainer shield 43. As a result, after shield 43 is deformed, each of first and second bags 41, 42 will be exposed to an external impact force to change from the inflated shape to a deflated shape so that right-side ride down pad 21 absorbs external energy associated with external impact force 20 to minimize g-loads experienced by child 100 seated in juvenile vehicle seat 10.

In the illustrated embodiment, an inner shell 90, and outer shell 92, and a partition 91 located between inner and outer shells 90, 92 cooperate to form first and second bags 41, 42 as suggested in FIG. 4. An inner surface 91a of partition 91 mates with inner shell 90 to form first air chamber 50 therebetween and to define first bag 41. An outer surface 91b of partition 91 mates with outer shell 92 to form second air chamber 60 therebetween and to define second bag 42. Entirely separate first and second bags could also be used and fall within the scope of the present disclosure. Each of air-discharge ports 51, 52, 61, 62 are arranged to face (i.e., open) toward an interior wall 45i of side wall 45 of deformable bag-shape retainer shield 43 as suggested for example, in FIGS. 2, 4, and 5.

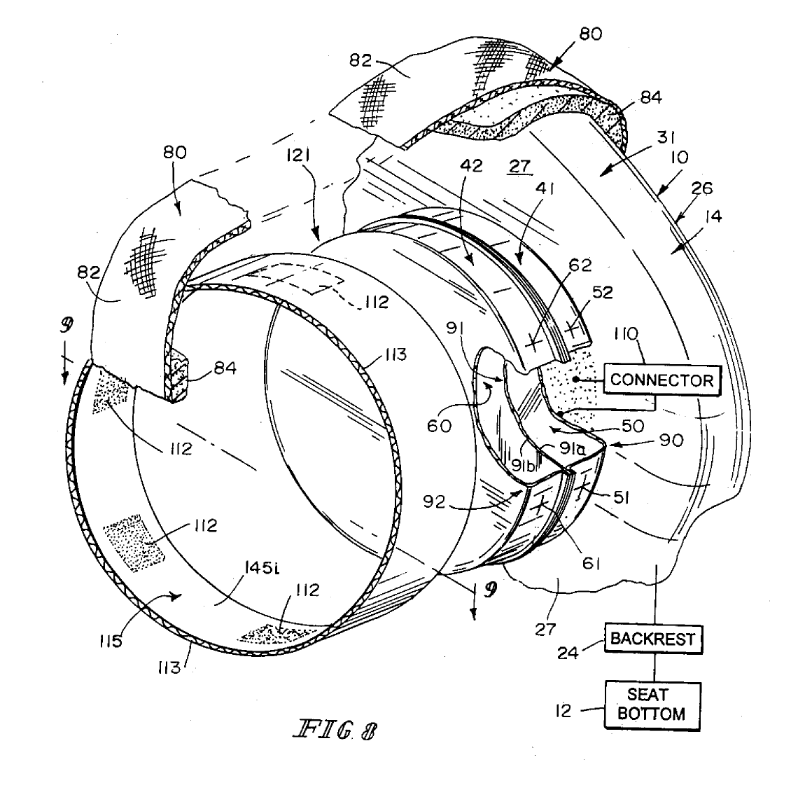

In a second embodiment of the present disclosure, a child restraint 111 includes right-side and left-side ride-down pads 121, 122 as shown in FIG. 6. In this second embodiment, right-side ride-down pad 121 includes first bag 41, second bag 42, and a deformable bag-shape retainer shield 143 as suggested in FIGS. 7-10. Left-side ride-down pad 122 is similar in construction to right-side ride-down pad 121.

Deformable bag-shape retainer shield 143 is configured to provide means for retaining each of first and second bags 41, 42 in its inflated shape until a sufficient external impact force 20 is applied to juvenile vehicle seat 10 to cause deformation of deformable bag-shape retainer shield 143 as suggested in FIG. 10 so that premature deflation of first and second bags 41, 42 is avoided. Deformable bag-shape retainer shield 143 is an endless strip of pliable (e.g., corrugated) material that is arranged to surround perimeter edges of first and second bags 41, 42 as suggested in FIGS. 7-10. In one illustrative embodiment, that pliable material is somewhat bendable and shapeable when exposed to external impact forces 20 as suggested in FIG. 10. In another illustrative embodiment, that pliable material is relatively inelastic and is crushed when deformed.

Deformable bag-shape retainer shield 143 is formed to include an interior region 146 containing first and second bags 41, 42 therein as suggested in FIGS. 7, 9, and 10. In an illustrative embodiment, first bag 41 is coupled to inner wall 27 of first side-wing panel 31 using a connector 110 (e.g., adhesive or hook-and-loop fastener) as suggested in FIG. 8 and perimeter edges of first and second bags 41, 42 are coupled to an interior wall 145i of shield 143 using adhesive 112 or other suitable connector as suggested in FIGS. 7-10. Each of air-discharge ports 51, 52, 61, 62 are arranged to face (i.e., open) toward an interior wall 145i of shield 43 as suggested, for example, in FIGS. 7, 9, and 10.

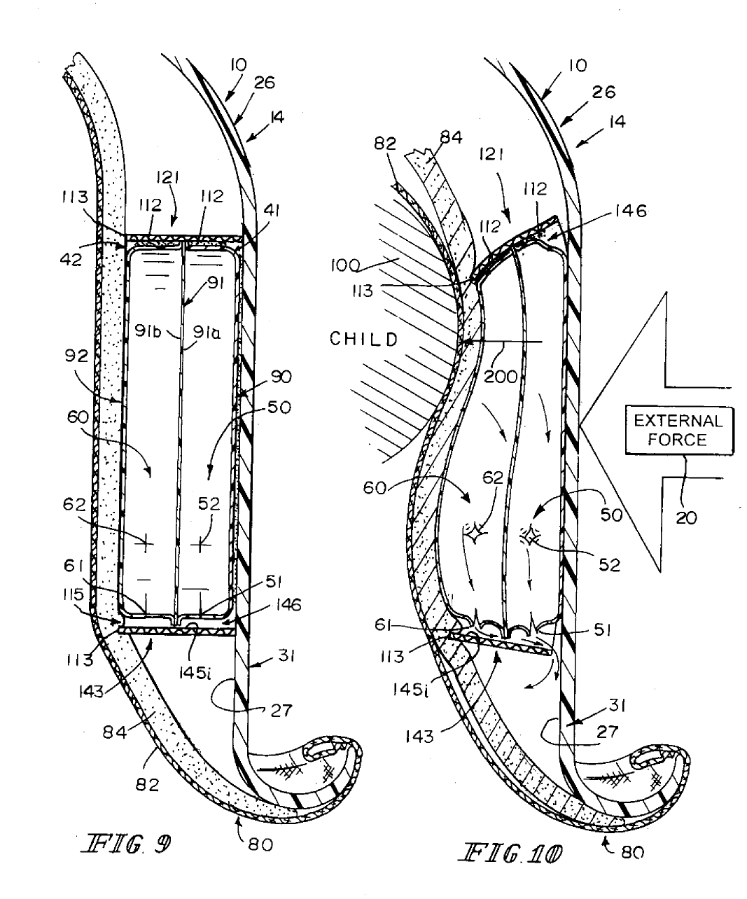

Deformable bag-shape retainer shield 143 includes a top edge 113 configured to form a top aperture 115 opening into a bag-receiving space defined by interior region 146. Second bag 42 is arranged to occlude top aperture 115 when first and second bags 41, 42 are arranged to lie in interior region 146 to assume their inflated shapes as suggested in FIGS. 7 and 9.

1. A child restraint comprising
a juvenile vehicle seat and
an energy-dissipation system coupled to the juvenile vehicle seat, the energy-dissipation system including a first ride-down pad including a first bag formed to include a first air chamber and a normally closed first air-discharge port opening into the first air chamber and a deformable bag-shape retainer shield coupled to the juvenile vehicle seat to form a bag-receiving space bounded at least in part by the juvenile vehicle seat and the deformable bag-shape retainer shield, wherein the first air chamber in the first bag is filled with air to cause the first bag normally to assume an inflated shape, the first bag is located in the bag-receiving space normally to remain in the inflated shape, the first air-discharge port is formed to include means for discharging air from the first air chamber to surroundings outside the first bag at a metered rate when the first bag is exposed to an external impact force to change from the inflated shape to a deflated shape so that the first ride-down pad absorbs external energy associated with the external impact force to minimize g-loads experienced by a child seated in the juvenile vehicle seat, and the deformable bag-shape retainer shield is made of a deformable material to assume a predetermined shape to retain the first bag in the inflated shape until the deformable bag-shape retainer shield is deformed and the first bag is exposed to the external impact force.

2. The child restraint of claim 1, wherein the deformable bag-shape retainer shield includes a side wall arranged to surround a perimeter edge of the first air bag and a top wall coupled to the side wall to lie in spaced-apart relation to the juvenile vehicle seat to locate the bag-receiving space therebetween, the top wall is arranged to cooperate with the side wall to form an interior region of the deformable bag-shape retainer shield, and the first bag is retained in the interior region in the inflated shape until the deformable bag-shape retainer shield is deformed to apply an external impact force to the first bag to cause air in the first air chamber to be discharged through the first air-discharge port and to cause the first bag to assume the deflated shape.

3. The child restraint of claim 2, wherein the first ride-down pad further includes a second bag formed to include a second air chamber and a normally closed second air-discharge port opening into the second air chamber, the second air chamber in the second bag is filled with air to cause the second bag normally to assume an inflated shape, the second bag is arranged to lie in the bag-receiving space in a position located between the first bag and the top wall of the deformable bag-shape retainer shield, the second air-discharge port is formed to include means for discharging air from the second air chamber into the interior region of the deformable bag-shape retainer shield at a metered rate in response to exposure of the second bag to an external impact force caused by deformation of the deformable bag-shape retainer shield.

4. The child restraint of claim 3, wherein the first air-discharge port is arranged to communicate with the interior region of the deformable bag-shape retainer shield to cause air to be discharged from the first air chamber into the interior region in response to an external impact force applied to the first bag by the second bag during discharge of air from the second air chamber through the second air-discharge port.

5. The child restraint of claim 3, wherein each of the first and second air chambers contains only air when the first and second bags are retained in their inflated shapes.

6. The child restraint of claim 2, wherein the side wall is defined by an endless strip of a plastics material.

7. The child restraint of claim 6, wherein the top wall is made of the plastics material and is arranged to cooperate with the side wall to form a monolithic element.

8. The child restraint of claim 6, wherein the side wall includes a bottom edge arranged to mate with the juvenile vehicle seat.

9. The child restraint of claim 2, wherein the side wall includes a bottom edge arranged to mate with the juvenile vehicle seat and a top edge coupled to the top wall.

10. The child restraint of claim 2, wherein the energy-dissipation system further includes anchor means for coupling the side wall to the juvenile vehicle seat.

11. The child restraint of claim 2, wherein the first air-discharge port is arranged to communicate with the interior region of the deformable bag-shape retainer shield.

12. The child restraint of claim 11, wherein the first air-discharge port is arranged to face toward the side wall of the deformable bag-shape retainer shield.

13. The child restraint of claim 1, wherein the deformable bag-shape retainer shield is an endless strip of pliable material arranged to surround a perimeter edge of the first bag.

14. The child restraint of claim 13, wherein the first bag is coupled to the juvenile vehicle seat and the deformable bag-shape retainer shield is coupled to the first bag to allow movement of the deformable bag-shape retainer shield relative to the juvenile vehicle seat during discharge of air from the first air chamber through the first air-discharge port as the first bag is changed from the inflated shape to the deflated shape.

15. The child restraint of claim 13, wherein the first ride-down pad further includes a second bag formed to include a second air chamber and a normally closed second air-discharge port opening into the second air chamber, the second air chamber in the second bag is filled with air to cause the second bag normally to assume an inflated shape, the second bag is located in the bag-receiving space normally to remain in the inflated shape, the second air-discharge port is formed to include means for discharging air from the second air chamber to surroundings outside the second bag at a metered rate when the second bag is exposed to an external impact force to change from the inflated shape to a deflated shape, the second bag is arranged to lie in spaced-apart relation to the juvenile vehicle seat to trap the first bag between the juvenile vehicle seat and the second bag, and the endless strip of pliable material is arranged to surround perimeter edges of both of the first and second bags.

16. The child restraint of claim 15, wherein the endless strip of material includes a top edge configured to form a top aperture opening into the bag-receiving space and the second bag is arranged to occlude the top aperture when the first and second bags are arranged to assume their inflated shapes.

17. The child restraint of claim 14, wherein the second bag is coupled to the endless strip of pliable material.

18. The child restraint of claim 15, wherein the second bag is coupled to the first bag and free to move relative to the endless strip of pliable material.

19. The child restraint of claim 15, wherein the first bag is coupled to the juvenile vehicle seat, the second bag is coupled to the first bag, and the deformable bag-shape retainer shield is coupled to at least one of the first and second bags to allow movement of the deformable bag-shape retainer shield relative to the juvenile vehicle seat during discharge of air from the first air chamber through the first air-discharge port and from the second air chamber through the second air-discharge port as each of the first and second bags is changed from the inflated shape to the deflated shape.

20. A child restraint comprising
a juvenile vehicle seat and
an energy-dissipation system coupled to the juvenile vehicle seat, wherein the energy-dissipation system includes a first ride-down pad including a first bag coupled to the juvenile vehicle seat and filled with air normally to assume an inflated shape, a second bag normally filled with air to assume an inflated shape and arranged to lie in spaced-apart relation to the juvenile vehicle seat to trap the first bag therebetween, and a deformable bag-shape retainer shield arranged to surround perimeter edges of the first and second bags to retain each of the first and second bags in the inflated shape until the first ride-down pad is exposed to an external impact force to cause the first ride-down pad to absorb external energy associated with the external impact force to minimize g-loads experienced by a child seated in the juvenile vehicle seat.

21. The child restraint of claim 20, wherein the deformable bag-shape retainer shield includes a side wall arranged to surround perimeter edges of the first and second bags and coupled to the juvenile vehicle seat and a top wall coupled to the side wall and arranged to trap the second bag between the top wall and the first bag.

22. The child restraint of claim 20, wherein the deformable bag-shape retainer shield includes an endless strip of pliable material arranged to surround perimeter edges of the first and second bags and formed to include a top aperture opening into a bag-receiving space containing the first and second bags and the second bag is arranged to occlude the aperture when the first and second bags are arranged to assume their inflated shapes.
